(19) United States
(12) Patent Application Publication
(10) Pub. No.: US 2010/0273033 A1
(43) Pub. Date: Oct. 28, 2010

(54) SECONDARY BATTERY

(76) Inventors: Masato FUJIKAWA, Osaka (JP); Tomohiko Yokoyama, Osaka (JP)

Correspondence Address: MCDERMOTT WILL & EMERY LLP, 600 13TH STREET, NW, WASHINGTON, DC, 20005-3096, US

(21) Appl. No.: 12/767,309

(22) Filed: Apr. 26, 2010

(30) Foreign Application Priority Data
Apr. 27, 2009 (JP) 2009-107475

(51) Int. Cl. H01M 2/00

(52) U.S. Cl. 429/61

(57) ABSTRACT

Positive and negative electrode plates are respectively joined to positive and negative electrode terminals through leads. At least one of the leads joined to the positive or negative electrode plate is made of a stack of first and second metal layers. The first metal layer has a resistance higher than that of the second metal layer. The second metal layer has a melting point lower than that of the first metal layer. When a short-circuit current flows in the secondary battery, current is concentrated in the second metal layer to cause a blowout of the second metal layer, and then, an increase in an heat generation amount due to an increase in a current density of a short-circuit current flowing in the first metal layer causes a blowout of the first metal layer, thereby causing a blowout of the lead to interrupt the short-circuit current.

### CROSS-REFERENCE TO RELATED APPLICATION

This application claims priority from Japanese application JP2009-107475 filed on Apr. 27, 2009, the disclosure of which application is hereby incorporated by reference into this application in its entirety for all purposes.

### BACKGROUND

Lithium ion batteries have light weight and high energy densities, and thus, are widely used as power sources for portable equipment and other devices. In general, a lithium ion battery is configured such that an electrode group formed by winding or stacking a positive electrode plate and a negative electrode plate with a separator interposed therebetween is housed in a battery case whose opening is sealed by a sealing member. The positive electrode plate and the negative electrode plate are respectively joined, through leads, to a positive electrode terminal constituted by the sealing member and a negative electrode terminal constituted by the battery case.

When an external short circuit occurs between external terminals of the battery, an excessive short-circuit current flows, and the battery generates heat, thereby overheating the battery in some cases.

As an example means for preventing overheating of a battery due to such a short-circuit current, a technique which employs a lead functioning as a fuse is described in, for example, Japanese Patent Publications Nos. H11-345630 and H08-185850. Specifically, when an excessive short-circuit current flows in the lead, resistance heating causes a blowout of the lead, thereby blocking a path for the short-circuit current and, as a result, preventing overheating of the battery.

The structure of a lead which does not function as a fuse but has high corrosion resistance and high weldability is described in, for example, Japanese Patent Publications Nos. H11-297300 and 2004-63132.

### SUMMARY

This Summary is provided to introduce a selection of concepts in a simplified form that are further described below in the Detailed Description. It is not intended to identify key features of the claimed subject matter, nor is it intended to be used as an aid in determining the scope of the claimed subject matter.

The invention disclosed and claimed herein, in one aspect thereof, is directed to a secondary battery in which an electrode group including a positive electrode plate, a negative electrode plate, and a porous insulating film interposed between the positive electrode plate and the negative electrode plate is housed in a battery case. In this secondary battery, the positive electrode plate and the negative electrode plate are respectively joined to a positive electrode terminal and a negative electrode terminal through leads, at least one of the leads joined to one of the positive electrode plate and the negative electrode plate is made of a stack of at least one first metal layer and a second metal layer, the first metal layer has a resistance higher than that of the second metal layer, and the second metal layer has a melting point lower than that of the first metal layer. When a short-circuit current flows in the secondary battery, current is concentrated in the second metal layer to cause a blowout of the second metal layer, and then, an increase in an heat generation amount due to an increase in a current density of a short-circuit current flowing in the first metal layer causes a blowout of the first metal layer, thereby causing a blowout of the at least one of the leads and interrupting the short-circuit current.

In another aspect, the at least one of the leads includes is made of the stack in which the second metal layer is sandwiched between the first metal layers. In this case, the first metal layers provided on both surfaces of the second metal layer preferably have an identical thickness.

In a preferred embodiment, the at least one of the leads is the lead joined to the negative electrode plate, the first metal layer is made of nickel, and the second metal layer is made of copper.

In a preferred embodiment, the second metal layer has a percentage ranging from 5% to 30%, by volume, and more preferably, from 5% to 20%, by volume.

In a preferred embodiment, the at least one of the leads is the lead joined to the positive electrode plate, the first metal layer is made of stainless steel, and the second metal layer is made of aluminium.

In a preferred embodiment, the second metal layer has a percentage ranging from 5% to 50%, by volume, and more preferably, from 5% to 30%, by volume.

In a preferred embodiment, the at least one of the leads has a cross-sectional area ranging from 0.2 mm² to 0.5 mm².

In a preferred embodiment, the following equation is satisfied:

2.5≦C/S≦15

where S (mm²) is a cross-sectional area of the at least one of the leads and C (Ah) is a capacity of the secondary battery.

### BRIEF DESCRIPTION OF THE DRAWINGS

FIG. 1 is a diagram illustrating a model circuit for calculating the amount of heat generation of a lead.

FIG. 2 is a graph showing the relationship between the heat generation amount W_{L} of a lead and resistance R_{L} of the lead.

FIG. 3 is a cross-sectional view illustrating a configuration of a secondary battery according to an embodiment of the present invention.

FIG. 4 is a cross-sectional view illustrating a structure of a negative electrode lead of the embodiment.

FIGS. 5A-5C are views for explaining a mechanism of a blowout of a lead when a short-circuit current flows in a secondary battery.

FIG. 6 is a graph showing the relationship between the heat generation amount W necessary for a blowout of a lead and the ratio of a stack.

FIG. 7 is a cross-sectional view showing a configuration of a secondary battery including a tabless electrode group.

### DETAILED DESCRIPTION

To function as a fuse, a lead requires an amount of heat generation that is large enough to cause a blowout of the lead through resistance heating caused by a short-circuit current.

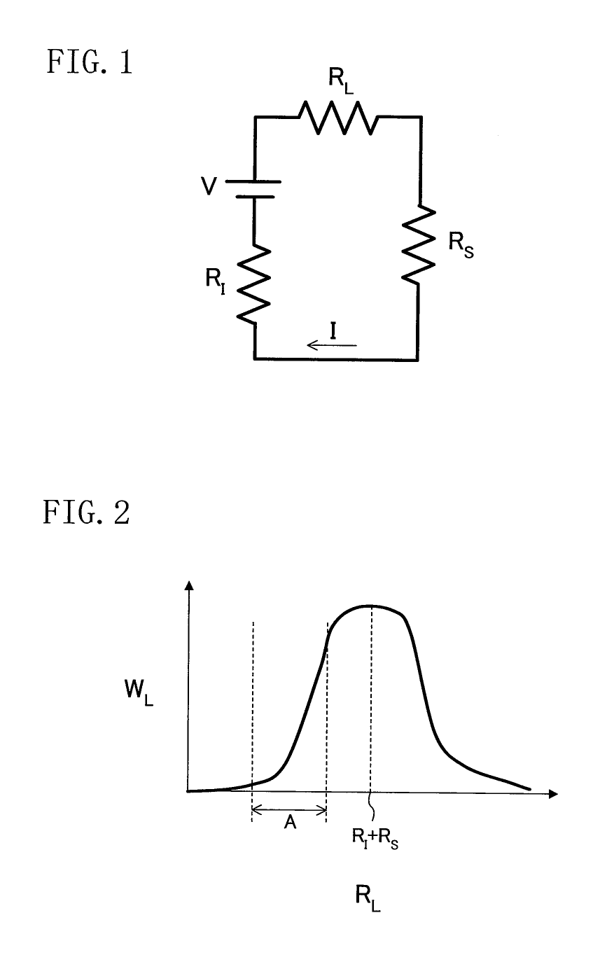

FIG. 1 is a diagram illustrating a model circuit for calculating the amount of heat generation of a lead. The heat generation amount W_{L} of the lead can be obtained by the following equation (1):

$$\begin{matrix}{W}_{L} = {I}^{2} \times {R}_{L} \\ = {R}_{L} \times {V}^{2} / {( {R}_{L} + {R}_{I} + {R}_{S} )}^{2}\end{matrix} \qquad ( 1 )$$

where V is the voltage of a secondary battery, R_{I} is the internal resistance of the secondary battery, R_{S} is the resistance of a short circuit, R_{L} is the resistance of a lead, and I is a short-circuit current.

FIG. 2 is a graph showing the relationship between the heat generation amount W_{L} of a lead and resistance R_{L} of the lead. From Equation (1), the heat generation amount W_{L} of the lead is at the maximum when R_{L}=R_{I}+R_{S}.

In general, the internal resistance R_{I} of a lithium ion battery is about several tens of mΩ, whereas the resistance R_{L} of a lead is about several mΩ. Thus, the relationship between the heat generation amount W_{L} of a lead and the resistance R_{L} of the lead falls in the range of a region A shown in FIG. 2.

Accordingly, to increase the heat generation amount of a lead at a flow of a short-circuit current in order to allow the lead to function as a fuse, it is necessary to increase the specific resistance of the lead or to reduce the cross-sectional area of the lead.

Since a lead material for a secondary battery needs to have high corrosion resistance to an electrolyte and high weldability to an electrode or a battery case, this material is selected only in a narrow range. It is therefore important to reduce the cross-sectional area of the lead in order to increase the heat generation amount of the lead.

A lead is generally coupled to one side of a current collector constituting part of an electrode plate, and thus, is preferably in the shape of a thin plate. Accordingly, to reduce the cross-sectional area of the lead, the lead needs to be thin. If a battery has a large capacity and a large current flows during a short circuit, a lead does not need to be very thin in order to generate an amount of heat which is large enough to cause a blowout of the lead. However, if a battery has a small capacity and a short-circuit current has a small value, the lead needs to be very thin in order to cause a blowout of the lead. In this case, the strength of the lead decreases. Thus, when an external shock or the like is applied to the secondary battery, the lead might be broken, thereby loosing the battery function.

It is therefore an object of the present invention to provide a secondary battery including a reliable lead having a fuse function.

Embodiments of the present invention will be described hereinafter with reference to the drawings. It should be noted that the present invention is not limited to the following embodiments. Various changes and modifications may be made without departing from the scope of the present invention. The following embodiments may be combined as necessary.

### First Embodiment

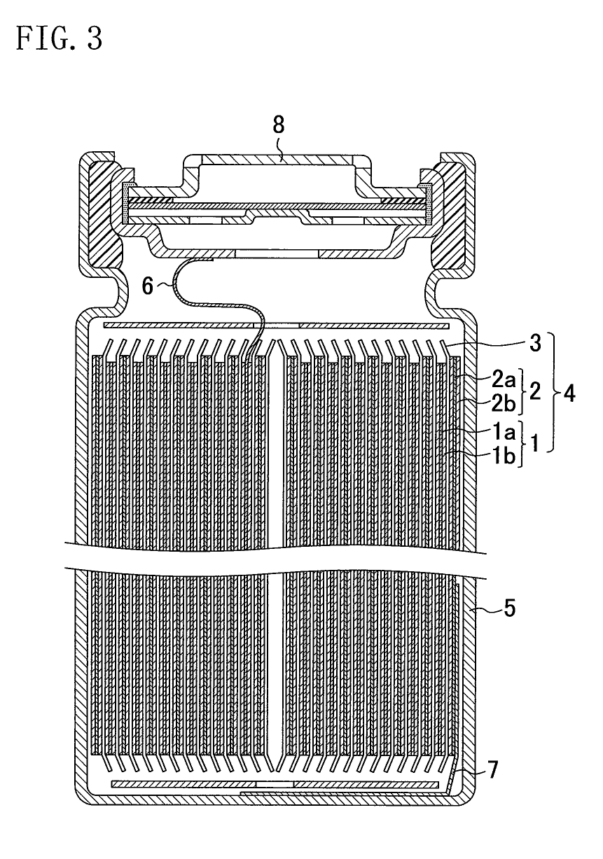

FIG. 3 is a cross-sectional view illustrating a configuration of a secondary battery according to a first embodiment of the present invention.

As illustrated in FIG. 3, an electrode group 4 formed by disposing a positive electrode plate 1 and a negative electrode plate 2 with a separator (a porous insulating film) 3 is housed in a battery case 5 whose opening is sealed by a sealing plate 8 also serving as a positive electrode terminal.

In the positive electrode plate 1, positive electrode material mixture layers 1b are formed on both surfaces of a positive electrode current collector 1a. In the negative electrode plate 2, negative electrode mixture layers 2b are formed on both surfaces of a negative electrode current collector 2a. An end of a positive electrode lead 6 is joined to an end of the positive electrode plate 1 where the positive electrode current collector 1a is exposed, whereas the other end of the positive electrode lead 6 is joined to the back surface of the sealing plate 8. An end of a negative electrode lead 7 is joined to an end of the negative electrode plate 2 where the negative electrode current collector 2a is exposed, whereas the other end of the negative electrode lead 7 is joined to the bottom of the battery case 5 also serving as a negative electrode terminal. In other words, the positive electrode plate 1 and the negative electrode plate 2 are respectively joined to the positive electrode terminal 8 and the negative electrode terminal 5 through the positive electrode lead 6 and the negative electrode lead 7.

A secondary battery of this disclosure has features in the structure(s) of the positive electrode lead 6 and/or the negative electrode lead 7. In the following description, the negative electrode lead 7 is used as an example. However, the description is also applicable to the positive electrode lead 6, of course.

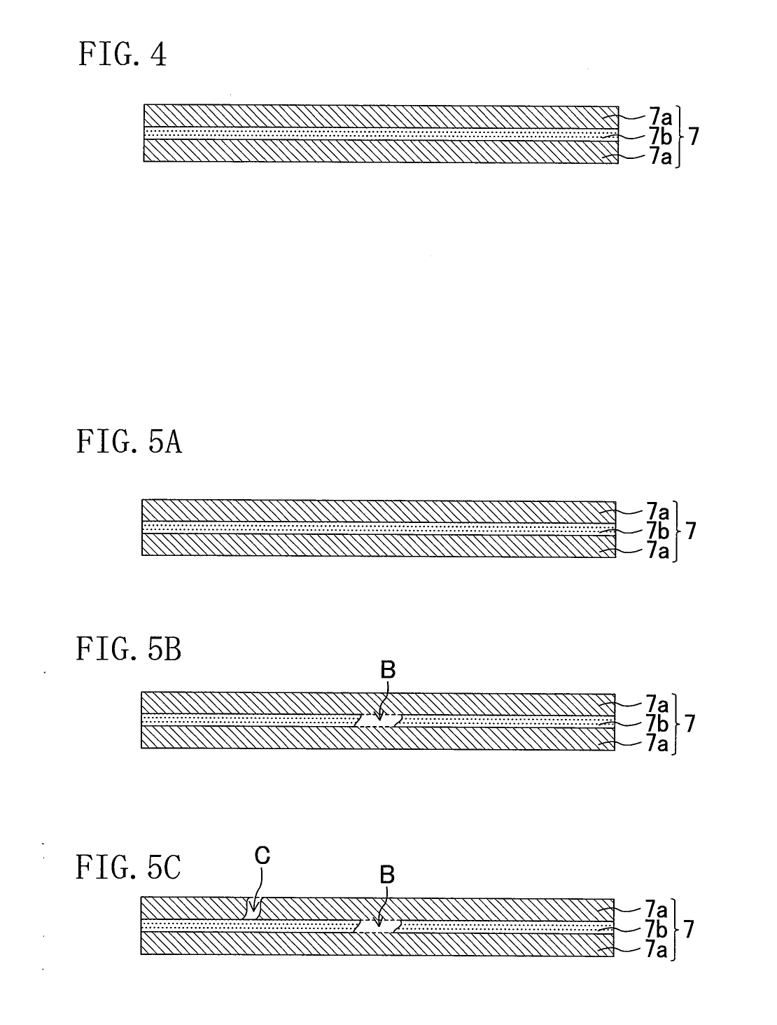

FIG. 4 is a cross-sectional view illustrating a configuration of the negative electrode lead 7 of this embodiment. As illustrated in FIG. 4, the negative electrode lead 7 is made of a stack of first metal layers 7a and a second metal layer 7b. FIG. 4 shows an example of a three-layer stack in which the second metal layer 7b is sandwiched between the first metal layers 7a. However, the negative electrode lead 7 may be a two-layer stack of the first metal layer 7a and the second metal layer 7b.

In this embodiment, the resistance of the first metal layers 7a is higher than that of the second metal layer 7b. The melting point of the second metal layer 7b is lower than that of the first metal layers 7a. When a short-circuit current flows in the secondary battery, the negative electrode lead 7 made of a stack of the metal layers 7a and 7b having such different properties is blown through the following mechanisms, which will be described below with reference to FIGS. 5A-5C.

First, when a short-circuit current flows in the lead 7 made of a stack as illustrated in FIG. 5A, the current is concentrated in the second metal layer 7b having a low resistance, and the second metal layer 7b is heated through resistance heating. Consequently, as illustrated in FIG. 5B, the second metal layer 7b having a low melting point is easily blown. Thereafter, the short-circuit current does not flow in this second metal layer 7b, and flows only in the first metal layers 7a. Consequently, the current density of the short-circuit current flowing in the first metal layers 7a increases, and accordingly, the amount of heat generation caused by resistance heating of the first metal layers 7a increases. In this manner, as illustrated in FIG. 5C, the first metal layers 7a are blown by self-heating, thereby blowing the lead 7 and, thus, interrupting the short-circuit current.

Specifically, a conventional lead is blown by heating through resistance heating of itself. On the other hand, the lead of the present disclosure is made of a stack of two types of metal layers having different resistances and melting points, and thus, has the features obtained through a two-step blowout mechanism: (1) one type of metal layer having a low melting point is preferentially blown by concentrating a short-circuit current in this type of metal layer having a low resistance; and then (2) the other type of metal layer having a high melting point is easily blown with an increase in the heat generation amount caused by an increase in the current density of a current flowing this type of metal layer having a high resistance.

In the first step, the first metal layers 7a having a high resistance function as a current block for causing current to preferentially flow in the second metal layer 7b having a low resistance. In the second step, the second metal layer 7b functions as a reinforcing member for the first metal layers 7a which are formed thin in order to ease a blowout. In this manner, the lead 7 can be easily blown when a short circuit current flows, thereby quickly interrupting a short-circuit current, and thus, reducing overheating of the secondary battery. Since the lead 7 is a stack of layers, the lead 7 has a high strength. Accordingly, when an external shock or the like is applied to the secondary battery, breakage of the lead can be reduced. As a result, a reliable secondary battery with high safety can be obtained.

The lead 7 of this disclosure is preferably made of a stack in which the second metal layer 7b is sandwiched between the first metal layers 7a. With this structure, escape of heat from the second metal layer 7b heated through resistance heating to outside can be reduced, thereby efficiently increasing the temperature of the second metal layer 7b. In addition, to reduce heat dissipation more efficiently, the first metal layers 7a on both surfaces of the second metal layer 7b preferably have an identical thickness.

In the present disclosure, the volume ratio (i.e., the ratio of the stack) between the first metal layers 7a and the second metal layer 7b is not specifically limited, and may be set in a preferred range in consideration of the resistances and the melting points of these layers and the value of a short-circuit current, for example.

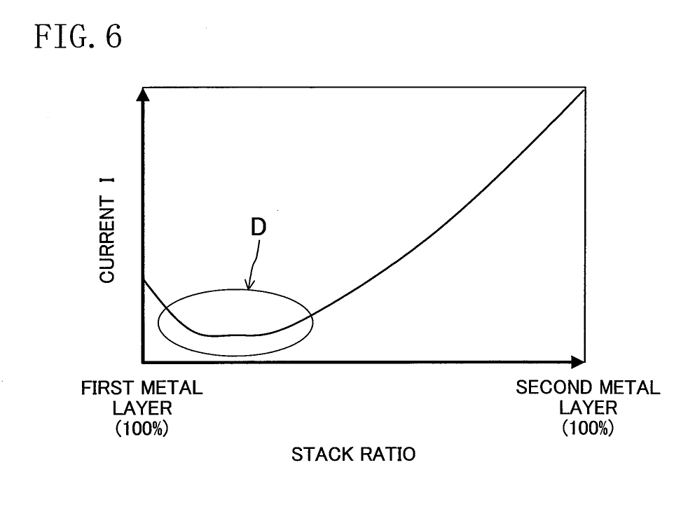

In the present disclosure, the stack ratio and a current I necessary for causing a blowout of the lead 7 qualitatively have a relationship as shown in FIG. 6.

If the percentage of the first metal layers 7a is 100%, the lead 7 has a high resistance. Thus, the heat generation amount is large relative to the value of a short-circuit current, and the temperature of the lead 7 easily increases. However, since the negative electrode lead 7 has a high melting point, a large amount of current is necessary for a blowout. On the other hand, if the percentage of the second metal layer 7b is 100%, the lead 7 has a low resistance. Thus, even with an increase in short-circuit current, the heat generation amount does not increase, and the lead 7 is not easily blown.

On the other hand, if the lead 7 is made of a stack having a ratio in a certain range, even when a total amount of current is small to some degree, the current is concentrated in the second metal layer 7b having a low resistance. Accordingly, the second metal layer 7b having a low melting point is easily blown. Thereafter, the cross-sectional area of the entire lead 7 decreases, thereby increasing the current density of the first metal layers 7a. Therefore, even the first metal layers 7a having a high melting point can be blown with a relatively small current. As a result, as shown in FIG. 6, by setting the ratio of the stack in the range of a region D, the lead 7 can be easily blown even with a small amount of a short-circuit current.

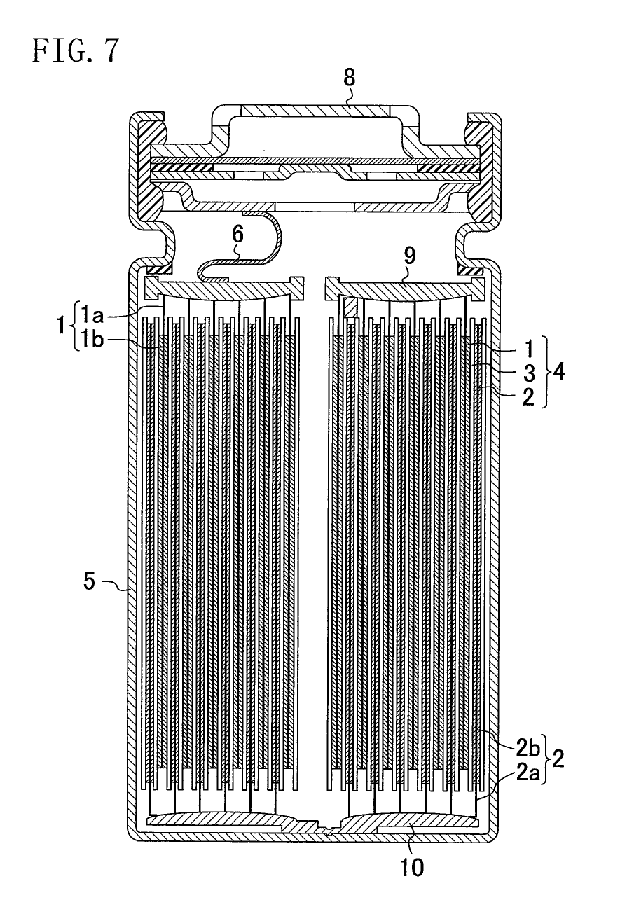

The term “lead” herein is not limited to that of the secondary battery including the electrode group 4 as illustrated in FIG. 3, but may be applied to a secondary battery including an electrode group 4 having a so-called tabless structure as illustrated in FIG. 7. In the secondary battery of FIG. 7, an end of a positive electrode current collector 1a projecting from a separator 3 is joined to the back surface of a positive electrode current collector plate 9. An end of a positive electrode lead 6 is joined to the top surface of the positive electrode current collector plate 9, whereas the other end of the positive electrode lead 6 is joined to the back surface of the sealing plate 8. In other words, the positive electrode plate 1 is joined to the sealing plate 8 through the positive electrode lead 6. Accordingly, a reliable secondary battery with high safety can also be obtained by using a lead made of a stack of the present disclosure as the positive electrode lead 6.

In addition, in the present disclosure, materials for the first metal layers 7a and the second metal layer 7b are not specifically limited, but preferably have high corrosion resistance and high weldability. For example, a combination of materials for the first metal layers and the second metal layer may be a combination of nickel and copper (respectively associated with the first and second metal layers in this order) or a combination of a nickel-copper alloy and copper (respectively associated with the first and second metal layers in this order), for example.

A specific structure of a lead of this embodiment will be described hereinafter with a negative electrode lead 7 of a lithium ion secondary battery used as an example. Here, the negative electrode lead 7 is a three-layer stack of Ni/Cu/Ni as illustrated in FIG. 4 in which first metal layers 7a are made of nickel (Ni) and a second metal layer 7b is made of copper (Cu). The Ni has a specific resistance of 6.9 μΩ·cm and a melting point of 1455° C., and Cu has a specific resistance of 1.7 μΩ·cm and a melting point of 1084° C.

Table 1 shows results of a short-circuit test performed by forming lithium ion secondary batteries (Examples 1-10) including negative electrode leads 7 in which the volume percentage of Cu varies in the range from 0% to 100%. In Example 1, the negative electrode lead 7 is a Ni single layer (where the volume percentage of Cu is 0%), and the negative electrode lead 7 of Example 10 is a Cu single layer (where the volume percentage of Cu is 100%). Fabrication of the lithium ion secondary batteries and the short-circuit test were conducted through the following procedures.

### [Table 1]

### (a) Formation of Positive Electrode Plate

First, 3 kg of lithium cobaltate as a positive electrode active material, 1 kg of “#1320 (product name)” manufactured by Kureha Corporation (i.e., an N-methyl-2-pyrrolidone (NMP) solution containing 12%, by weight, of PVDF as a positive electrode binder, 90 g of acetylene black as a conductive agent, and an appropriate amount of NMP were stirred with a kneading machine, thereby preparing positive electrode material mixture slurry. This slurry was then applied onto both surfaces of 15-μm-thick aluminium foil serving as a positive electrode current collector 1a, and was dried. The dried coated film was rolled with a roller, thereby forming a positive electrode material mixture layer 1b. The thickness of the resultant positive electrode plate 1 was 160 μm. Thereafter, the positive electrode plate 1 was cut to have a width of 56 mm. A positive electrode lead 6 made of aluminium and having a width of 3 mm and a thickness of 0.1 mm was joined by welding to an uncoated portion of the positive electrode material mixture layer 1b.

### (b) Formation of Negative Electrode

First, 3 kg of artificial graphite as a negative electrode active material, 75 g of “BM-400B (product name) manufactured by Zeon Corporation as a negative electrode binder (i.e., aqueous dispersion containing 40%, by weight, of denatured styrene-butadiene copolymer), 30 g of sodium carboxymethyl cellulose (CMC) as a thickener, and an appropriate amount of water were stirred with a kneading machine, thereby preparing negative electrode material mixture slurry. This slurry was then applied onto both surfaces of 10-μm-thick copper foil serving as a negative electrode current collector 2a, and was dried. The dried coated film was rolled with a roller, thereby forming a negative electrode mixture layer 2b. The thickness of the resultant negative electrode plate 2 was 180 μm. Thereafter, the negative electrode plate 2 was cut to have a width of 57 mm. A negative electrode lead 7 made of a three-layer stack of Ni/Cu/Ni having a width of 3 mm and a thickness of 0.1 mm was joined by welding to an uncoated portion of the negative electrode mixture layer 2b. The Ni layers on both surfaces of the Cu layer had an identical thickness.

### (c) Preparation of Nonaqueous Electrolyte

First, LiPF₆ having a concentration of 1 mol/L was dissolved in a mixture of a nonaqueous solvent containing ethylene carbonate (EC) and ethyl methyl carbonate (EMC) at a volume ratio of 3:7. Then, 3 parts, by weight, of vinylene carbonate (VC) was added to each 100 parts, by weight, of the obtained solution, thereby obtaining a nonaqueous electrolyte.

### (d) Fabrication of Lithium Ion Secondary Battery

An electrode group 4 was formed by winding the positive electrode plate 1 and the negative electrode plate 2 with a 20-μm-thick polyethylene separator (a porous film) 3 interposed therebetween. An end of the positive electrode lead 6 was disposed in the inside of the electrode group 4, and an end of the negative electrode lead 7 was disposed on the outside of the electrode group 4.

The electrode group 4 was inserted in a battery case 5, and then the other end of the negative electrode lead 7 was welded to the inner bottom surface of the battery case 5. Thereafter, 5 g of a nonaqueous electrolyte was poured in the battery case 5, and the other end of the positive electrode lead 6 was welded to the lower surface of a sealing plate 8. Subsequently, the sealing plate 8 was inserted in the battery case 5, and an opening of the battery case 5 was sealed by crimping, thereby obtaining a lithium ion secondary battery. The design capacity was 2200 mAh.

### (e) Short-Circuit Test

First, each battery was subjected to preconditioning charge and discharge twice, and then was charged with a current of 400 mA until the voltage of the battery reaches 4.1 V. Then, the charged battery was stored for seven days in an atmosphere of 45° C. Thereafter, in an atmosphere of 20° C., the battery was charged and discharged through the following steps:

(1) Constant-current charge: a charge current of 1500 mA and a charge cut-off voltage of 4.2 V;

(2) Constant-voltage charge: a charge voltage of 4.2 V and a charge cut-off current of 100 mA; and

(3) Constant-current discharge: a discharge current of 2200 mA and a discharge cut-off voltage of 3 V.

Subsequently, in an atmosphere of 25° C., the positive and negative electrode terminals of the battery were short-circuited with a resistor of about 5 mΩ provided in an external circuit. Then, the battery temperature 90 sec. after the short circuit was measured.

As shown in Table 1, in batteries (Examples 3-6) in which the Cu percentage (i.e., the percentage of the second metal layer) was 5% to 30%, by volume, the battery temperature hardly increased after a short circuit. When each of the batteries after the test was disassembled, a blowout of the negative electrode lead 7 was found. This result is considered to be because a quick blowout of the negative electrode lead 7 after the short circuit quickly interrupted a short-circuit current, and thereby, prevented an increase in the battery temperature.

On the other hand, in batteries (Examples 1 and 2) in which the Cu percentage was less than 5%, by volume, the battery temperature after the short circuit increased to 100° C. or higher. When each of the batteries after the test was disassembled, it was found that the negative electrode lead 7 was not blown and, instead, a shutdown function due to dissolution of the separator 3 was performed. Specifically, continuation of a short-circuit state after the short-circuit and before a start of the shutdown function of the separator 3 allowed the battery to generate heat for a long period of time, resulting in an excessive rise of the battery temperature. This result is considered to be because of the following reason. In the example where the Cu percentage was less than 5%, by volume, even when the Cu layer having a low melting point was blown, the cross-sectional area of the Ni layers did not effectively decreases, and thus, an increase in the heat generation amount due to an increase in the current density of a short-circuit current flowing in the Ni layers could not be sufficiently obtained. As a result, the Ni layers were not blown.

Further, in batteries (Examples 7-10) in which the Cu percentage exceeded 30%, by volume, the battery temperature after the short circuit increased to 100° C. or higher. When each of the batteries after the test was disassembled, it was found that the negative electrode lead 7 was not blown and, instead, a shutdown function due to dissolution of the separator 3 was performed. Specifically, continuation of a short-circuit state after the short-circuit and before a start of the shutdown function of the separator 3 allowed the battery to generate heat for a long period of time, resulting in an excessive rise of the battery temperature. This result is considered to be because of the following reason. When the Cu percentage exceeds 30%, by volume, current is concentrated in the Cu layer to a small degree, and thus, the Cu layer was not blown.

Based on the foregoing results, if the negative electrode lead 7 is made of a three-layer stack of Ni/Cu/Ni, the percentage of the Ni layers is preferably in the range from 5% to 30%, by volume. To increase current concentration in the Cu layer so as to blow the Cu layer with a smaller current, the percentage of the Ni layers is more preferably in the range from 5% to 20%, by volume.

Next, in each of the lithium ion secondary batteries shown in Table 1, the negative electrode lead 7 was changed to a Cu single layer with a thickness of 0.1 mm, the positive electrode lead 6 was changed to a three-layer stack of SUS/Al/SUS in which first metal layers 6a were made of stainless steel (SUS) and a second metal layer 6b was made of aluminium (Al). The same short-circuit test was conducted on these batteries. In this structure, SUS has a specific resistance of 72 μΩ·cm and a melting point of 1400° C., and Al has a specific resistance of 2.8 μΩ·cm and a melting point of 660° C.

Table 2 shows the results. In Table 2, the positive electrode lead 6 of Example 11 was a SUS single layer (where the volume percentage of Al was 0%) and the positive electrode lead 6 of Example 19 was an Al single layer (where the volume percentage of Al was 100%).

### [Table 2]

As shown in Table 2, in batteries (Examples 13-16) in which the Al percentage (i.e., the percentage of the second layer) was in the range from 5% to 50%, by volume, the battery temperature after the short circuit hardly increased. When each of the batteries after the test was disassembled, a blowout of the positive electrode lead 6 was found. In other words, the positive electrode lead 6 was quickly blown after the short circuit, thereby quickly interrupting a short-circuit current, and thus, reducing an increase in the battery temperature.

On the other hand, in batteries (Examples 11 and 12) in which the Al percentage was less than 5%, by weight, the battery temperature after the short circuit increased to 100° C. or higher. When each of the batteries after the test was disassembled, it was found that the positive electrode lead 6 was not blown and, instead, a shutdown function due to dissolution of the separator 3 was performed. Specifically, continuation of a short-circuit state after the short-circuit and before a start of the shutdown function of the separator 3 allowed the battery to generate heat for a long period of time, resulting in an excessive rise of the battery temperature. This result is considered to be because of the following reason. In the examples where the Al percentage was less than 5%, by volume, even when the Al layer having a low melting point was blown, an effective decrease in the cross-sectional area of the SUS layers was small, and thus, an increase in the heat generation amount due to an increase in the current density of a short-circuit current flowing in the SUS layers could not be sufficiently obtained. As a result, the SUS layers were not blown.

Further, in batteries (Examples 17-19) in which the Al percentage exceeded 50%, by volume, the battery temperature after the short circuit increased to 100° C. or higher. When each of the batteries after the test was disassembled, it was found that the positive electrode lead 6 was not blown and, instead, a shutdown function due to dissolution of the separator 3 was performed. Specifically, continuation of a short-circuit state after the short-circuit and before a start of the shutdown function of the separator 3 allowed the battery to generate heat for a long period of time, resulting in an excessive rise of the battery temperature. This result is considered to be because of the following reason. When the Al percentage exceeded 50%, by volume, current was concentrated in the Al layer to a small degree, and thus, the Al layer was not blown.

Based on the foregoing results, if the positive electrode lead 6 is made of a three-layer stack of SUS/Al/SUS, the percentage of the Al layer is preferably in the range from 5% to 50%, by volume. To increase current concentration in the Al layer so as to blow the Al layer with a smaller current, the percentage of the Al layer is more preferably in the range from 5% to 30%, by volume.

In the present disclosure, materials for the first metal layers 6a and the second metal layer 6b are not specifically limited, but preferably have high corrosion resistance and high weldability. For example, a combination of materials for the first metal layers and the second metal layer may be a combination of stainless steel and aluminium (respectively associated with the first and second metal layers in this order) or a combination of titanium and aluminium (respectively associated with the first and second metal layers in this order), for example.

### Second Embodiment

As described above, in the structure of a stack forming a lead according to the present disclosure, the volume ratio between the first metal layers 6a (7a) and the second metal layer 6b (7b) is not specifically limited, and may be set in a preferred range in consideration of the resistances and the melting points of these layers and the value of a short-circuit current, for example.

In this embodiment, the preferred range of the cross-sectional area of the lead will be described in view of obtaining both an appropriate strength of the lead and a high energy density of the battery.

In this embodiment, a negative electrode lead 7 is made of a three-layer stack of Ni/Cu/Ni in which first metal layers 7a are made of nickel (Ni) and a second metal layer 7b is made of copper (Cu) and the volume ratio among Ni/Cu/Ni is 40/20/20, as an example.

Lithium ion secondary batteries (Examples 21-30) using the negative electrode leads 7 formed with the cross-sectional area varied by changing the width of the negative electrode leads 7 were fabricated. Then, a drop test and test of inserting the electrode group into the case were performed. Table 3 shows the results.

### [Table 3]

The lithium ion secondary batteries were fabricated in the same manner as for the battery of Example 5 except for the variation in the cross-sectional area of the negative electrode leads 7. The drop test and the insertion test of the electrode group were performed through the following procedures.

### (a) Drop Test

First, each 50 batteries were subjected to preconditioning charge and discharge twice, and were charged with a current of 400 mA until the voltage of the batteries reaches 4.1 V. Then, the charged batteries were stored for seven days in an atmosphere of 45° C. Thereafter, in an atmosphere of 20° C., the batteries were charged and discharged through the following steps:

(1) Constant-current charge: a charge current of 1500 mA and a charge cut-off voltage of 4.2 V;

(2) Constant-voltage charge: a charge voltage of 4.2 V and a charge cut-off current of 100 mA; and

(3) Constant-current discharge: a discharge current of 2200 mA and a discharge cut-off voltage of 3 V.

Subsequently, in an atmosphere of 25° C., each battery was dropped from a height of 1.6 m 50 times. Then, an alternating current (AC) impedance of the dropped battery at 1 kHz was measured. Batteries showing a 10% or more increase in the AC impedance were considered as damaged batteries. The rate of occurrence of damaged batteries are shown in Table 3.

### (b) Electrode Group Insertion Test

Next, each 50 batteries in the state of electrode groups were prepared, and the resistance between the positive and negative electrode leads inserted in the case was measured for each of the batteries. Batteries exhibiting resistances of 1 MΩ or less were considered as batteries which were short-circuited during insertion. The rates of occurrence of such batteries are shown in Table 3.

As shown in Table 3, in batteries (Examples 21-23) having small cross-sectional areas, the AC impedance increased in the drop test. When each of the batteries after the test was disassembled, it was found that a portion of the negative electrode lead 7 showing a break or a crack was blown. In other words, the cross-sectional area of the negative electrode lead 7 was considered to decrease to reduce the strength of the negative electrode lead 7. On the other hand, in batteries (Examples 29 and 30) having large cross-sectional areas, a short circuit occurs in the insertion test of the electrode group. This is considered to be because of the following reason. The use of the lead having a large cross-sectional area increased the diameter of the electrode group and caused the lead to come into contact with the case during insertion, thereby causing a short circuit due to, for example, damage on the separator.

Based on the foregoing results, to obtain both an appropriate strength of the lead and a high energy density of the battery, the cross-sectional area of the lead is preferably in the range from 0.2 mm² to 0.5 mm².

### Third Embodiment

As described above, in a stack forming a lead according to the present disclosure, the volume ratio between the first metal layers 6a (7a) and the second metal layer 6b (7b) is not specifically limited, and may be set in a preferred range in consideration of the resistances and the melting points of these layers and the value of a short-circuit current, for example.

In this embodiment, the preferred range of the cross-sectional area of the lead will be described in view of obtaining both high power of the battery and safety in the occurrence of an external short circuit.

Lithium ion secondary batteries (Examples 31-54) using negative electrode leads 7 formed with the battery capacity varied by changing the length of the positive and negative electrodes and with the cross-sectional area also varied were fabricated. Then, a high-rate discharge test and a short-circuit test were performed. Table 4 shows the results.

### [Table 4]

The lithium ion secondary batteries were fabricated in the same manner as for the battery of Example 1. The high-rate discharge test was performed through procedures described below. The short-circuit test was performed through the same procedures as those in Table 1.

### (a) High-Rate Discharge Test

First, each battery was subjected to preconditioning charge and discharge twice, and was charged with a current of 0.2×C A until the voltage of the battery reaches 4.1 V. Then, the charged battery was stored for seven days in an atmosphere of 45° C. Thereafter, in an atmosphere of 20° C., the battery was charged and discharged through the following steps:

(1) Constant-current charge: a charge current of 0.7×C A and a charge cut-off voltage of 4.2 V;

(2) Constant-voltage charge: a charge voltage of 4.2 V and a charge cut-off current of 0.05×C A; and

(3) Constant-current discharge: a discharge current of 0.2×C A and a discharge cut-off voltage of 3 V.

Table 4 shows the results where the rate of the capacity with a current of 2×C A to the capacity with a current of 0.2×C A is expressed as a high-rate discharge characteristic (%). Table 4 also shows whether a blowout occurred or not in the short-circuit test.

As shown in Table 4, in batteries (Examples 37, 43, 49, and 50) where C/S was less than 2.5, no blowouts of the negative electrode leads 7 occurred. Specifically, since the batteries had small capacities and had high internal resistances relative to the cross-sectional areas of the negative electrode leads 7, the value of the short-circuit current was small and, as a result, no blowouts occurred. On the other hand, batteries (Examples 34-36 and 42) where C/S was higher than 15 exhibited poor high-rate discharge characteristics. This result is considered to be because of the following reason. In the case of using a negative electrode lead 7 having a small cross-sectional area in a battery having a large capacity and a large amount of discharge current, a high resistance of the negative electrode lead 7 increased the resistance of the battery, thereby degrading high-rate discharge characteristics.

Based on the foregoing results, to obtain both high power of a battery and safety in the occurrence of an external short circuit, the cross-sectional area of the lead is preferably in the range of 2.5≦C/S≦15 where S (mm²) is the cross-sectional area of the lead and C (Ah) is the capacity of the secondary battery.

It should be recognized that the foregoing description has been set forth for purposes of preferred embodiments of the present invention, and is not intended to limit the scope of the invention, and various changes and modifications may be made. For example, in the above embodiments, the lithium ion secondary batteries were described as examples of secondary batteries. Alternatively, the present disclosure may be applicable to nickel-metal hydride batteries, nickel-cadmium batteries, and other batteries, and also applicable to rectangular secondary batteries as well as round-cylindrical secondary batteries.

TABLE 1

| | | | | PROPORTION OF | LEAD | BATTERY |
|---|---|---|---|---|---|---|
| | LEAD | FIRST | SECOND | SECOND METAL | BREAKAGE | TEMPERATURE |
| | THICKNESS | METAL | METAL | LAYER | AT SHORT | AFTER SHORT |
| | (mm) | LAYER | LAYER | (% BY VOLUME) | CIRCUIT | CIRCUIT (° C.) |
| EXAMPLE 1 | 0.10 | Ni | Cu | 0 | NOT FOUND | 132 |
| EXAMPLE 2 | 0.10 | Ni | Cu | 3 | NOT FOUND | 131 |
| EXAMPLE 3 | 0.10 | Ni | Cu | 5 | FOUND | 32 |
| EXAMPLE 4 | 0.10 | Ni | Cu | 10 | FOUND | 29 |
| EXAMPLE 5 | 0.10 | Ni | Cu | 20 | FOUND | 30 |
| EXAMPLE 6 | 0.10 | Ni | Cu | 30 | FOUND | 29 |
| EXAMPLE 7 | 0.10 | Ni | Cu | 40 | NOT FOUND | 128 |
| EXAMPLE 8 | 0.10 | Ni | Cu | 50 | NOT FOUND | 130 |
| EXAMPLE 9 | 0.10 | Ni | Cu | 80 | NOT FOUND | 129 |
| EXAMPLE 10 | 0.10 | Ni | Cu | 100 | NOT FOUND | 127 |

TABLE 2

| | | | | PROPORTION OF | LEAD | BATTERY |
|---|---|---|---|---|---|---|
| | LEAD | FIRST | SECOND | SECOND METAL | BREAKAGE | TEMPERATURE |
| | THICKNESS | METAL | METAL | LAYER | AT SHORT | AFTER SHORT |
| | (mm) | LAYER | LAYER | (% BY VOLUME) | CIRCUIT | CIRCUIT (° C.) |
| EXAMPLE 11 | 0.10 | SUS | Al | 0 | NOT FOUND | 126 |
| EXAMPLE 12 | 0.10 | SUS | Al | 3 | NOT FOUND | 131 |
| EXAMPLE 13 | 0.10 | SUS | Al | 5 | FOUND | 28 |
| EXAMPLE 14 | 0.10 | SUS | Al | 10 | FOUND | 30 |
| EXAMPLE 15 | 0.10 | SUS | Al | 30 | FOUND | 31 |
| EXAMPLE 16 | 0.10 | SUS | Al | 50 | FOUND | 30 |
| EXAMPLE 17 | 0.10 | SUS | Al | 60 | NOT FOUND | 129 |
| EXAMPLE 18 | 0.10 | SUS | Al | 80 | NOT FOUND | 133 |
| EXAMPLE 19 | 0.10 | SUS | Al | 100 | NOT FOUND | 131 |

TABLE 3

| | CROSS- | DROP TEST | OCCURRENCE OF |
|---|---|---|---|
| | SECTIONAL | DAMAGE | SHORT CIRCUIT IN |
| | AREA OF | OF LEAD | ELECTRODE |
| | LEAD (mm) | (%) | INSERTION TEST (%) |
| EXAMPLE 21 | 0.05 | 18 | 0 |
| EXAMPLE 22 | 0.1 | 8 | 0 |
| EXAMPLE 23 | 0.15 | 2 | 0 |
| EXAMPLE 24 | 0.2 | 0 | 0 |
| EXAMPLE 25 | 0.3 | 0 | 0 |
| EXAMPLE 26 | 0.4 | 0 | 0 |
| EXAMPLE 27 | 0.45 | 0 | 0 |
| EXAMPLE 28 | 0.5 | 0 | 0 |
| EXAMPLE 29 | 0.55 | 0 | 4 |
| EXAMPLE 30 | 0.6 | 0 | 10 |

TABLE 4

| | | CROSS- | | HIGH-RATE | |
|---|---|---|---|---|---|
| | BATTERY | SECTIONAL | | DISCHARGE | LEAD BREAKAGE |
| | CAPACITY | AREA OF LEAD | | CHARACTERISTIC | AT SHORT |
| | C (Ah) | S (mm) | C/S | (%) | CIRCUIT |
| EXAMPLE 31 | 0.5 | 0.2 | 2.5 | 78.5 | FOUND |
| EXAMPLE 32 | 1.0 | 0.2 | 5.0 | 75.5 | FOUND |
| EXAMPLE 33 | 2.0 | 0.2 | 10.0 | 72.4 | FOUND |
| EXAMPLE 34 | 3.0 | 0.2 | 15.0 | 63.2 | FOUND |
| EXAMPLE 35 | 4.0 | 0.2 | 20.0 | 60.5 | FOUND |
| EXAMPLE 36 | 5.0 | 0.2 | 25.0 | 58.8 | FOUND |
| EXAMPLE 37 | 0.5 | 0.3 | 1.7 | 79.2 | NOT FOUND |
| EXAMPLE 38 | 1.0 | 0.3 | 3.3 | 78.6 | FOUND |
| EXAMPLE 39 | 2.0 | 0.3 | 6.7 | 76.6 | FOUND |
| EXAMPLE 40 | 3.0 | 0.3 | 10.0 | 74.2 | FOUND |
| EXAMPLE 41 | 4.0 | 0.3 | 13.3 | 73.9 | FOUND |
| EXAMPLE 42 | 5.0 | 0.3 | 16.7 | 63.4 | FOUND |
| EXAMPLE 43 | 0.5 | 0.4 | 1.3 | 77.8 | NOT FOUND |
| EXAMPLE 44 | 1.0 | 0.4 | 2.5 | 76.6 | FOUND |
| EXAMPLE 45 | 2.0 | 0.4 | 5.0 | 76.2 | FOUND |
| EXAMPLE 46 | 3.0 | 0.4 | 7.5 | 75.9 | FOUND |
| EXAMPLE 47 | 4.0 | 0.4 | 10.0 | 75 | FOUND |
| EXAMPLE 48 | 5.0 | 0.4 | 12.5 | 74.1 | FOUND |
| EXAMPLE 49 | 0.5 | 0.5 | 1.0 | 78.4 | NOT FOUND |
| EXAMPLE 50 | 1.0 | 0.5 | 2.0 | 78 | NOT FOUND |
| EXAMPLE 51 | 2.0 | 0.5 | 4.0 | 77.5 | FOUND |
| EXAMPLE 52 | 3.0 | 0.5 | 6.0 | 77.3 | FOUND |
| EXAMPLE 53 | 4.0 | 0.5 | 8.0 | 76.5 | FOUND |
| EXAMPLE 54 | 5.0 | 0.5 | 10.0 | 73 | FOUND |

What is claimed is:

1. A secondary battery in which an electrode group including a positive electrode plate, a negative electrode plate, and a porous insulating film interposed between the positive electrode plate and the negative electrode plate is housed in a battery case, wherein
the positive electrode plate and the negative electrode plate are respectively joined to a positive electrode terminal and a negative electrode terminal through leads,
at least one of the leads joined to one of the positive electrode plate and the negative electrode plate is made of a stack of a first metal layer and a second metal layer,
the first metal layer has a resistance higher than that of the second metal layer,
the second metal layer has a melting point lower than that of the first metal layer, and
when a short-circuit current flows in the secondary battery, current is concentrated in the second metal layer to cause a blowout of the second metal layer, and then, an increase in an heat generation amount due to an increase in a current density of a short-circuit current flowing in the first metal layer causes a blowout of the first metal layer, thereby causing a blowout of the at least one of the leads and interrupting the short-circuit current.

2. The secondary battery of claim 1, wherein the at least one of the leads is made of the stack in which the second metal layer is sandwiched between the first metal layers.

3. The secondary battery of claim 2, wherein the first metal layers provided on both surfaces of the second metal layer have an identical thickness.

4. The secondary battery of claim 1, wherein the at least one of the leads is the lead joined to the negative electrode plate,
the first metal layer is made of nickel, and
the second metal layer is made of copper.

5. The secondary battery of claim 4, wherein the second metal layer has a percentage ranging from 5% to 30%, by volume.

6. The secondary battery of claim 4, wherein the second metal layer has a percentage ranging from 5% to 20%, by volume.

7. The secondary battery of claim 1, wherein the at least one of the leads is the lead joined to the positive electrode plate,
the first metal layer is made of stainless steel, and
the second metal layer is made of aluminium.

8. The secondary battery of claim 7, wherein the second metal layer has a percentage ranging from 5% to 50%, by volume.

9. The secondary battery of claim 7, wherein the second metal layer has a percentage ranging from 5% to 30%, by volume.

10. The secondary battery of claim 1, wherein the at least one of the leads has a cross-sectional area ranging from 0.2 mm² to 0.5 mm².

11. The secondary battery of claim 1, wherein the following equation is satisfied:
2.5≦C/S≦15
where S (mm²) is a cross-sectional area of the at least one of the leads and C (Ah) is a capacity of the secondary battery.

12. The secondary battery of claim 1, wherein the secondary battery is a lithium ion secondary battery.
